(19) United States
(12) Patent Application Publication
(10) Pub. No.: US 2008/0059069 A1
(43) Pub. Date: Mar. 6, 2008

(54) System and method for detecting an object in the path of a vehicle

(76) Inventor: William R. Trutna, Atherton, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/512,683

(22) Filed: Aug. 30, 2006

(51) Int. Cl. G08G 1/16

(52) U.S. Cl. 701/301

(57) ABSTRACT

Correlation-based motion sensor modules similar to those used in optical mice are applied to systems and methods for detecting an object in the path of a vehicle. A system for detecting an object in the path of a vehicle includes at least two correlation-based motion sensor modules and a detection engine. Each of the correlation-based motion sensor modules includes a sensor array, optics, and a correlation engine. The optics focus light onto the sensor array, the sensor array generates frames of image information, and the correlation engine correlates the frames of image information to generate an indication of the relative displacement of an object. The detection engine uses the indications of relative displacement from the correlation-based motion sensor modules to detect an object in the path of a vehicle.

### BACKGROUND OF THE INVENTION

Designers are continually looking for ways to make vehicles more intelligent. One area of particular interest in vehicle design is on-board systems that can detect an object in the path of a vehicle early enough to enable a collision to be avoided. Of particular interest in highly urbanized areas, is a system that can detect a pedestrian in the path of a vehicle in time to avoid a pedestrian-vehicle collision.

Systems utilizing video processing and radar have been developed to detect an object in the path of a vehicle. However, the solutions that have been developed so far are either not able to reliably detect objects such as pedestrians in the path of a vehicle or they are too expensive to implement.

### SUMMARY OF THE INVENTION

Correlation-based motion sensor modules similar to those used in optical mice are applied to systems and methods for detecting an object in the path of a vehicle. A system for detecting an object in the path of a vehicle includes at least two correlation-based motion sensor modules and a detection engine. Each of the correlation-based motion sensor modules includes a sensor array, optics, and a correlation engine. The optics focus light onto the sensor array, the sensor array generates frames of image information, and the correlation engine correlates the frames of image information to generate an indication of the relative displacement of an object. The detection engine uses the indications of relative displacement from the correlation-based motion sensor modules to detect an object in the path of a vehicle.

A method for detecting an object in the path of a vehicle involves establishing first and second fields-of-view within which frames of image information can be captured, wherein the fields-of-view are oriented to overlap in the path of a vehicle, capturing frames of image information from within the first and second fields-of-view, using the frames of image information captured from within the first field-of-view to generate an indication of relative displacement of an object within the first field-of-view, using the frames of image information captured from within the second field-of-view to generate an indication of relative displacement of the object within the second field-of-view, and using the indications of relative displacement to detect an object in the path of the vehicle.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a sensor array, a lens, and the resulting field-of-view of the sensor array.

FIG. 2 depicts an object that is moving within the field-of-view of a sensor array.

FIG. 3 depicts a vehicle with correlation-based motion sensor modules mounted on the left and right sides of the vehicle's front bumper.

FIG. 4 illustrates a vehicle that is equipped with two clusters of correlation-based motion sensor modules along with the associated fields-of-view.

FIG. 5 depicts an expanded view of a cluster of six correlation-based motion sensor modules oriented with respect to each other such that their fields-of-view are adjacent to each other.

FIG. 6 illustrates a vehicle that is equipped with two clusters of correlation-based motion sensor modules in the case where another vehicle and a tree are located outside the detection area.

FIG. 7 depicts a side view of a vehicle equipped with a correlation-based detection system in which the fields-of-view have been tilted upward to avoid road-induced interference.

FIG. 8 depicts an embodiment of a vehicle-based object detection system that utilizes correlation-based motion tracking to detect an object in the path of a vehicle.

FIG. 9 depicts an example of an integrated circuit that includes a sensor array and an integrated correlation engine.

FIG. 10 is a process flow diagram of a method for detecting an object in the path of a vehicle.

Throughout the description similar reference numbers may be used to identify similar elements.

### DETAILED DESCRIPTION

Correlation-based motion sensor modules have been widely used for navigation tracking in optical mice. Correlation-based motion sensor modules for optical mice typically include a light source, an image sensor, optics, and a correlation engine, which are used to track relative movement between the correlation-based motion sensor module and a navigation surface. The sensor arrays utilized for the correlation-based motion sensor modules are low resolution sensor arrays of, for example, up to 30×30 pixels (900 pixels). In contrast, digital cameras (still or video) commonly utilize a sensor array having, for example, 2,048×1,536 pixels (3.1 Megapixels). Because the low resolution sensor arrays have so many fewer pixels, they are cheaper to produce than the higher resolution sensor arrays.

In operation, the light source of a correlation-based sensor module illuminates the navigation surface at an oblique angle to accentuate surface contrast and the image sensor captures image frames of the illuminated navigation surface at a high rate (e.g., 1,000 frames per second). The correlation engine tracks relative movement between the correlation-based motion sensor module and the navigation surface by correlating common features that exist in successive image frames. In optical mouse applications, the movement between image frames is expressed in terms of movement vectors in, for example, the x- and y-directions (e.g., Δx and Δy). More detailed descriptions of exemplary correlation-based movement tracking techniques are provided in U.S. Pat. No. 5,644,139, entitled NAVIGATION TECHNIQUE FOR DETECTING MOVEMENT OF NAVIGATION SENSORS RELATIVE TO AN OBJECT, and U.S. Pat. No. 6,222,174, entitled METHOD OF CORRELATING IMMEDIATELY ACQUIRED AND PREVIOUSLY STORED FEATURE INFORMATION FOR MOTION SENSING, both of which are incorporated by reference herein.

In accordance with an embodiment of the invention, correlation-based motion sensor modules similar to those used in optical mice are applied to systems and methods for detecting an object in the path of a vehicle. In particular, a system for detecting an object in the path of a vehicle includes at least two correlation-based motion sensor modules and a detection engine. Each of the correlation-based motion sensor modules includes a sensor array, optics, and a correlation engine. The optics focus light onto the sensor array, the sensor array generates frames of image information, and the correlation engine correlates the frames of image information to generate an indication of the relative displacement of an object. The detection engine uses the indications of relative displacement from the correlation-based motion sensor modules to detect an object in the path of the vehicle.

The geometries in optical mouse navigation and vehicle-based object detection systems are vastly different. In particular, in optical mouse navigation, the correlation-based motion sensor module is typically within 10 millimeters of the navigation surface whereas with vehicle-based object detection systems, the objects of interest (e.g., pedestrians) are typically in a range of 5-25 meters from the vehicle. To accommodate the relatively large distance between a vehicle and an object of interest, a correlation-based motion sensor module for use in a vehicle-based object detection system is equipped with optics that focus the image sensor at a much greater distance (e.g., effectively infinity) than the optics used in optical mouse navigation. As is described in more detail below, because an object of interest is so far from the correlation-based motion sensor module, movement of the object across the image sensor in the x- and y-directions corresponds to angular motion as opposed to linear motion.

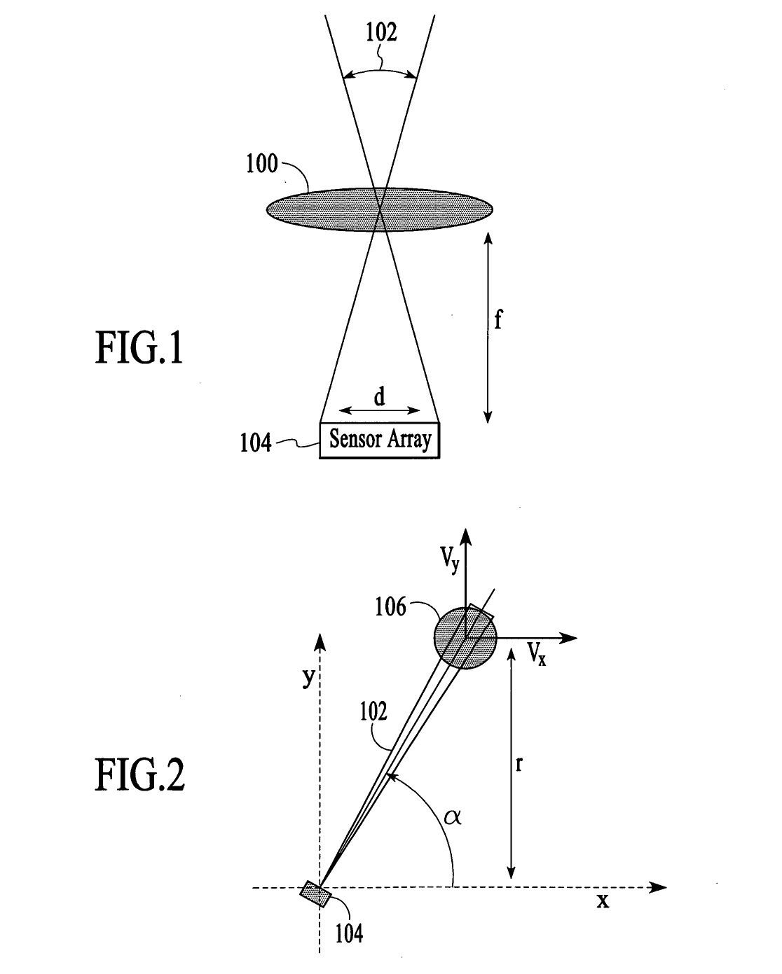

Referring to FIG. 1, the focal length of a lens 100 determines the field-of-view (FOV) 102 and the angular resolution of a sensor array 104. The field-of-view is defined by the width of the sensor, d, divided by the focal length of the lens, f. The sensor array generates image information only for objects that lie within the field-of-view. In an embodiment, the focal length of the lens is set at 10 mm and the sensor array is a 30×30 pixel array, with pixel spacing of approximately 60 μm. Given this configuration, the field-of-view is calculated as:

$$\frac{30 \times 60 μ m}{10000 μ m} = 0.18 radians or about 10.3 degrees .$$

Since there are 30 pixels spread across the 10.3 degree field-of-view, the angular resolution, i.e., the resolvable object angle change, θᵣₑₛ, is determined as 10.3 degrees divided by 30 or 0.3433 degrees. The correlation engine may utilize known interpolation-based techniques to detect relative motion as small as 1/16 of a pixel, which corresponds to 3.75 micrometers of image motion across the image sensor. At 1/16^{th} of a pixel resolution, the angular resolution improves to 0.0215 degrees, where the angular resolution is calculated as:

$$\frac{10.3 deg}{30 \times 16} = 0.0215 degrees .$$

Operation of a vehicle-based object detection system is now described in more detail with reference to FIGS. 2-10. FIG. 2 depicts an object 106 that is moving within the field-of-view 102 of a sensor array 104. The sensor array is oriented such that the normal to the center of the field-of-view of the sensor array is at an angle, a relative to the x-axis. The x and y components of the object's velocity are identified in FIG. 2 as Vₓ and V_{y}, respectively. The sensor array captures image frames as the object moves within the field-of-view of the sensor array. The captured image frames are used to determine the angular velocity of the object, where the angular velocity is a function of both the x and y velocity components of the object. The angular velocity is approximately defined as a function of the x and y velocity components as:

$$\frac{d α}{d t} ≅ \frac{{V}_{y} sin α cos α}{r} - \frac{{V}_{x} {sin}^{2} α}{r} \qquad ( 1 )$$

where r is the object range relative to the x-axis.

With only one angular velocity measurement, the x and y components of the object's velocity cannot be resolved. Additionally, the magnitude of the object's velocity cannot be measured without knowing the range. In accordance with an embodiment of the invention, at least two correlation-based motion sensor modules, which are attached to a vehicle and oriented with respect to each other to have overlapping fields-of-view in the path of the vehicle, are used to determine the object's range and the x and y components of the object's velocity relative to the vehicle.

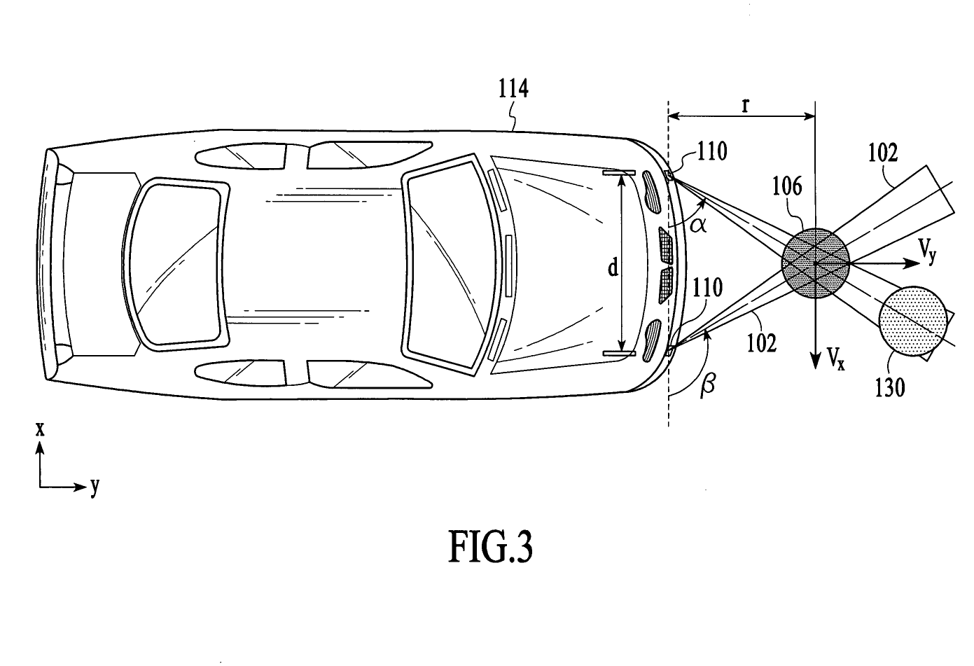

In an embodiment as depicted in FIG. 3, correlation-based motion sensor modules 110 are mounted on the left and right sides of the front bumper of a vehicle 114. With the correlation-based motion sensor modules separated by distance d and oriented such that their fields-of-view 102 are at angles α and β as indicated, the range r of an object at the intersection of the fields-of-view is determined from the following equation:

$$r = \frac{d sin α sin β}{sin ( β - α )} \qquad ( 2 )$$

Using dual correlation-based motion sensor modules 110 as depicted in FIG. 3, an object in the path of the vehicle will not be detected unless there is relative motion between the vehicle and the object. As described above, each correlation-based motion sensor module measures the angular velocity of an object within its field-of-view. The two angular velocities α and β are defined as a function of the x and y velocity components as:

$$\begin{matrix}\frac{d α}{d t} ≅ \frac{{V}_{y} sin α cos α}{r} - \frac{{V}_{x} {sin}^{2} α}{r} \\ and & ( 3 a ) \\ \frac{d β}{d t} ≅ \frac{{V}_{y} sin αβcos β}{r} - \frac{{V}_{x} {sin}^{2} β}{r} & ( 3 b )\end{matrix}$$

### Since the range, r, is known by triangulation (see equation 2), both components of the object's velocity, Vₓ and V_{y}, can be determined by solving a pair of linear equations (eqns. 3a and 3b) using the measured angular velocities

$$\frac{d α}{d t} and \frac{d β}{d t} .$$

Solving for Vₓ and V_{y} is particularly simple in the special, but important case in which α and β are supplementary angles (α=π−β). This describes the symmetric situation in which the object is centered directly in front of the vehicle. Because of the symmetry, an object moving only in the x direction causes α and β to decrease at the same rate. However, an object moving only in the y direction causes equal and opposite changes in α and β. Therefore, the difference between the two angular velocity measurements gives the y velocity component, while the sum of the two angular velocity measurements gives the x velocity component. For the case in which the object is centered directly in front of the vehicle, the calculations of the x and y velocity components resolve to:

$$\begin{matrix}{V}_{x} = \frac{- r ( \frac{d β}{d t} + \frac{d α}{d t} )}{2 {sin}^{2} β} = \frac{- r ( \frac{d β}{d t} + \frac{d α}{d t} )}{2 {sin}^{2} α} \\ and & ( 4 a ) \\ {V}_{y} = \frac{r ( \frac{d β}{d t} - \frac{d α}{d t} )}{2 sin β cos β} = \frac{- r ( \frac{d β}{d t} - \frac{d α}{d t} )}{2 sin α cos α} . & ( 4 b )\end{matrix}$$

### Equations 4a and 4b can be solved in with simple mathematical processing that is incorporated into an application-specific integrated circuit.

In sum, the above-described object detection system utilizes low resolution image frames and correlation processing to determine the angular velocities of an object relative to a vehicle. The angular velocities of the object are then used to calculate the range and the x and y components of the object's velocity relative to the vehicle. The range and/or velocity information generated by the object detection system are used by the vehicle to take some action. For example, the vehicle may sound an alarm or initiate a collision-avoidance measure in response to the range and/or velocity information. As shown by equations 2, 4a, and 4b, basic information about an object's range and relative velocity can be obtained with simple mathematical processing.

Referring again to FIG. 3, if the fields-of-view 102 of the correlation-based motion sensor modules 110 are increased, the coverage area of the object detection system is increased but the range accuracy is reduced. On the other hand, if the fields-of-view of the correlation-based motion sensor modules are decreased, the range accuracy increases but the coverage area of the object detection system decreases. Having good range accuracy is desirable. However, decreased fields-of-view increase the risk that an object in the path of a vehicle will not be detected. For design purposes, the coverage area for a vehicle-based object detection system should ideally span approximately 30 degrees at a range of 5-25 meters in front of a vehicle.

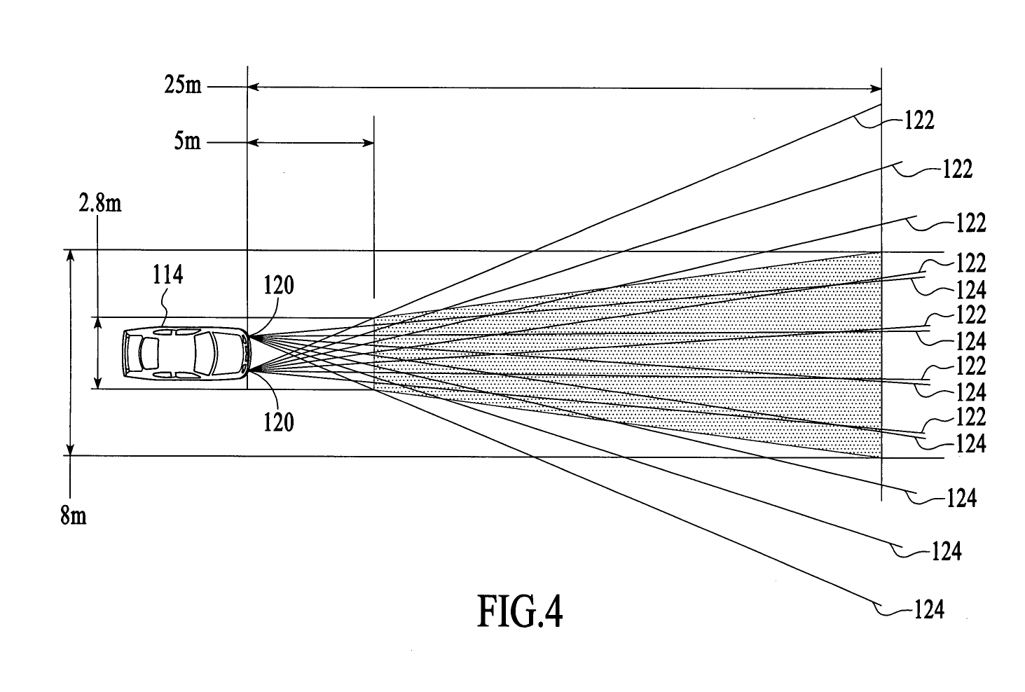

In accordance with an embodiment of the invention, good range accuracy and an expanded field-of-view are achieved by utilizing multiple correlation-based motion sensor modules that are oriented such that their respective fields-of-view are adjacent to each other, thereby creating combined fields-of-view that are wider than the field-of-view of any one correlation-based motion sensor module. For example, multiple correlation-based motion sensor modules are clustered together and oriented with respect to each other such that their fields-of-view are adjacent to each other. FIG. 4 illustrates a vehicle 114 that is equipped with two clusters 120 of correlation-based motion sensor modules relative to the corresponding fields-of-view. In the embodiment of FIG. 4, the correlation-based motion sensor modules are focused at infinity using 20 mm focal length lenses, which corresponds to a field-of-view of about 5.2 degrees and an angular resolution of about 0.011 degrees. Each cluster of correlation-based motion sensor modules includes six modules (not shown), with each module oriented at a different angle so that the corresponding fields-of-view cover adjacent five degree regions in a fan arrangement. The two clusters of correlation-based motion sensor modules are separated by approximately 1.7 meters. In FIG. 4, the lines 122 represent the boundaries of the fields-of-view of the left-side correlation-based motion sensor modules and the lines 124 represent the boundaries of the fields-of-view of the right-side correlation-based motion sensor modules. In the embodiment of FIG. 4, the angles, α, of the fields-of-view of the left-side modules range from 68 degrees to 93 degrees in 5 degree increments and the angles, β, of the fields-of-view of the right-side modules range from 87 degrees to 117 degrees in 5 degree increments.

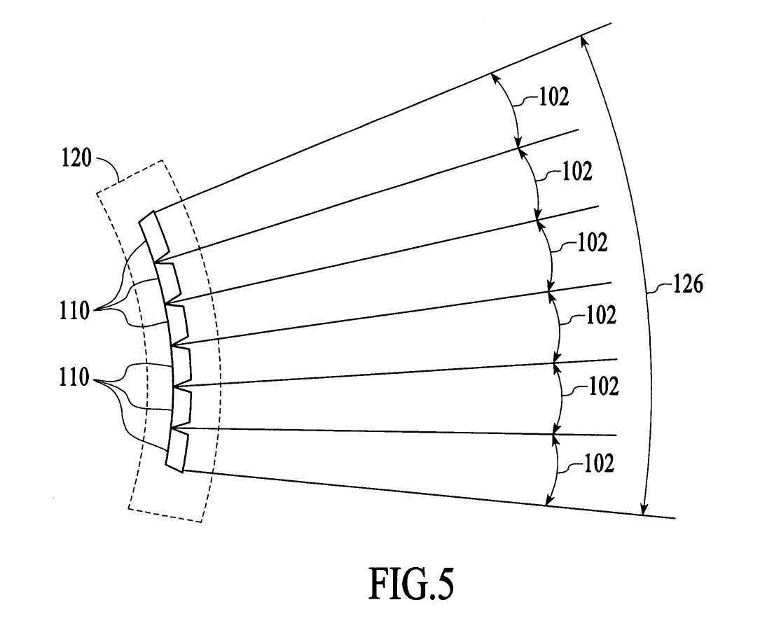

FIG. 5 depicts an expanded view of one of the clusters 120 of six correlation-based motion sensor modules 110 oriented with respect to each other such that their fields-of-view 102 are adjacent to each other. The fields-of-view of the six correlation-based motion sensor modules create a combined field-of-view 126.

Referring back to FIG. 4, the two clusters 120 of correlation-based motion sensor modules are oriented with respect to each other such that their fields-of-view overlap and each opposing pair of correlation-based motion sensor modules has fields-of-view that overlap at a different range and at a unique location. The two clusters of six correlation-based motion sensor modules result is an array of thirty-six unique image fields, eighteen of which lie all or partially within the desired detection coverage region. Each pair of opposing correlation-based motion sensor modules is designed to function as the single pair that is described with reference to FIG. 3 and each unique image field provides range and velocity information for an object within the respective image field.

In one example, a pedestrian is standing 25 meters directly in front of a vehicle that is approaching at 40 km/hr (11.1 meters/second). At 25 meters, the pedestrian is in the field-of-view of the left-side module that is aimed at α=88 degrees and in the field-of-view of the right-side module that is aimed at β=92 degrees. Substituting Vₓ=0 and V_{y}=11.1 m/s into equations 3a and 3b, the resulting angular velocity is

$$\frac{d α}{d t} = - 8.76 degrees \text{/} second = - \frac{d β}{d t} .$$

In this example, assume also a sampling rate of 10 Hz (10 samples/second), a frame capture rate of 500 to 6,000 frames per second, and an angular resolution of 0.011 degrees. At a vehicle rate of 11.1 meters/second and a sampling interval of 0.1 seconds, the object at 25 meters is detected approximately 2 seconds before impact and an object at 5 meters is detected approximately 0.4 seconds before impact. During one 0.1 second sampling interval, anywhere from 50 to 600 image frames are captured. In an embodiment, the image frames are correlated and the incremental x and y displacement calculated from each correlation is summed. At the end of each 0.1 second sampling interval, the summed x and y displacement is output for use in object detection. In an embodiment, the outputs are in terms of counts, where the term count refers to the digital number produced by the correlation-based motion sensor module. In this case, the counts correspond to the image shift in 1/16 pixel units during one sample period and approximately 80 counts would be generated during one 0.1 second sampling interval (since 8.8 degrees/second corresponds to 80 counts/0.1 second*0.011 degrees/count). Noise counts (i.e., outputs that indicate no displacement) have been experimentally measured at about ±1 counts root mean square such that 80 counts of real data are easily distinguished from noise.

Referring back to FIG. 3, if the object of interest does not lie at the intersection of the overlapping fields-of-view (see object 130), then motion will be detected by only one of the correlation-based motion sensor modules 110. Therefore, assuming the proper coverage area is established, objects that register motion through only one field-of-view can be assumed to be outside the path of the vehicle.

When one object is in the field-of-view of the object detection system, detection of the object is accomplished as described above with little concern for interference. In practical situations, the environment in and around the path of a moving vehicle is cluttered by many potentially interfering objects including, for example, other automobiles, lamp posts, fire hydrants, trash cans, and so on. The presence of so many objects in the system's field-of-view complicates object detection. In one embodiment, interfering signals are dealt with by recognizing that the angular velocity of an object outside the detection area is slower than the angular velocity of an object that is within the detection area. Given the difference between angular velocities, a threshold can be used to suppress false detections.

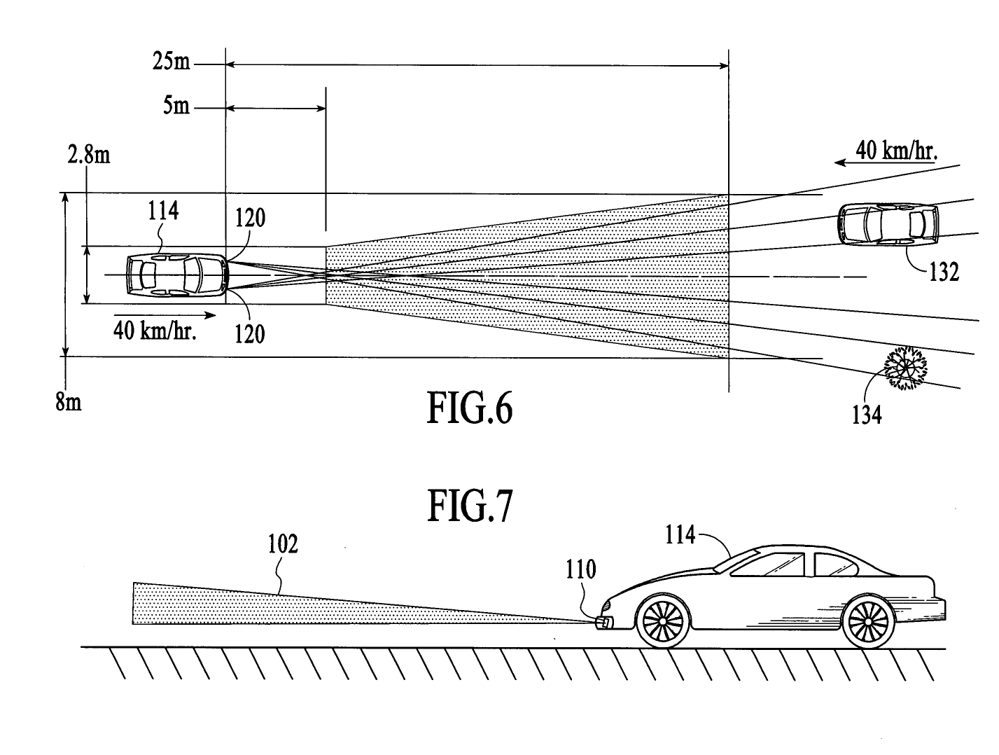

In one example, consider only one pair of correlation-based motion sensor modules, one aimed at α=83 degrees and the other aimed at β=97 degrees such that the corresponding fields-of-view overlap about seven meters in front of the vehicle. Instead of a single object seven meters in front of the vehicle, assume as shown in FIG. 6 that there are two additional objects (e.g., another vehicle 132 and a tree 134) on either side of the vehicle 114 at about 35 meters range. The right-side correlation-based motion sensor modules detect the oncoming vehicle on the left side of the vehicle and the left-side correlation-based motion sensor modules detect the tree on the right side of the vehicle. If the vehicle 114 with the detection system is the only object moving, the correlation-based motion sensor modules detect nearly equal and opposite angular rates for the other vehicle and the tree as predicted by equations 3a and 3b. However, since the range of the other vehicle and the tree is about five times the range of the object in the seven meter overlap region, the angular velocities of the other vehicle and the tree are roughly ⅕^{th} that of a pedestrian in the seven meter coverage area. Nevertheless, using equations 2, 4a, and 4b, the vehicle-based object detection system would determine that a pedestrian is in the detection area and approaching at ⅕^{th} the vehicle speed. Because the other vehicle and the tree are outside the detection area these determinations are considered false detections.

In accordance with an embodiment of the invention, false detections are avoided by establishing an angular velocity threshold that is a function of the dimensions of the detection area and the vehicle's speed. In particular, the angular velocity threshold is established at a value that excludes objects that are outside the detection area. Because the angular velocity of objects that are farther from the vehicle will be less than the angular velocity of object that are closer to the vehicle, a minimum angular velocity threshold can be used to exclude objects beyond a desired range. As is described above, the angular velocity of an object relative to a moving vehicle is a function of the vehicle's current speed and therefore, the angular velocity threshold is dynamically selected as a function of the vehicle's current speed. The measured angular velocity of an object is then compared to the angular velocity threshold and objects with angular velocities below the threshold are assumed to be outside of the detection area and are disregarded for collision-avoidance purposes.

Even in the case where the other vehicle is also moving, the measured angular velocity will still be relatively small compared to the angular velocity of an object that is within the detection area. Further, if the other vehicle is moving extremely fast, the result will be a large imbalance between the right-side and left-side angular velocities. The large imbalance between right-side and left-side angular velocities can be used to identify the object as being outside the detection area because large imbalances between angular velocities would not be expected for objects that are within the detection area.

In an embodiment, to avoid interference from the road itself, the correlation-based motion sensor modules are oriented such that their fields-of-view are tilted slightly upward. For example, the modules are tilted upwards so that their fields-of-view do not include the road within the effective range of the modules. FIG. 7 depicts a side view of a vehicle 114 equipped with a correlation-based motion sensor modules 110 oriented such that their fields-of-view 102 are tilted upward to avoid road-induced interference.

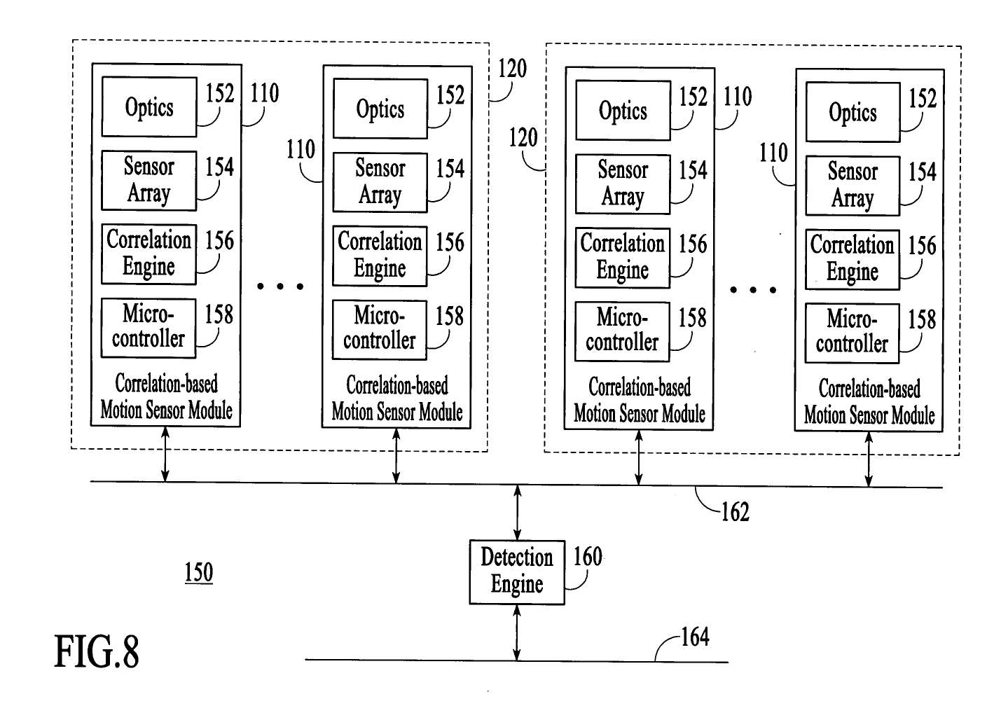

FIG. 8 depicts an embodiment of a vehicle-based object detection system 150 that utilizes correlation-based motion tracking as described above to detect an object in the path of a vehicle. The vehicle-based object detection system includes multiple correlation-based motion sensor modules 110 and a detection engine 160. The correlation-based motion sensor modules are organized into clusters 120 as described above, with each of the correlation-based motion sensor modules including optics 152, a sensor array 154, a correlation engine 156, and a microcontroller 158. The sensor array, optics, and correlation engine operate as described above and the microcontrollers perform functions such as initializing the correlation-based motion sensor modules and requesting angular velocity information. The angular velocity information is provided to the detection engine through a system bus 162. The detection engine receives the angular velocity information and generates range and linear velocity (e.g., in the x and y dimensions) information related to the object of interest as described above. The detection engine is then connected to a vehicle network 164 to communicate object detection information to other parts of the vehicle.

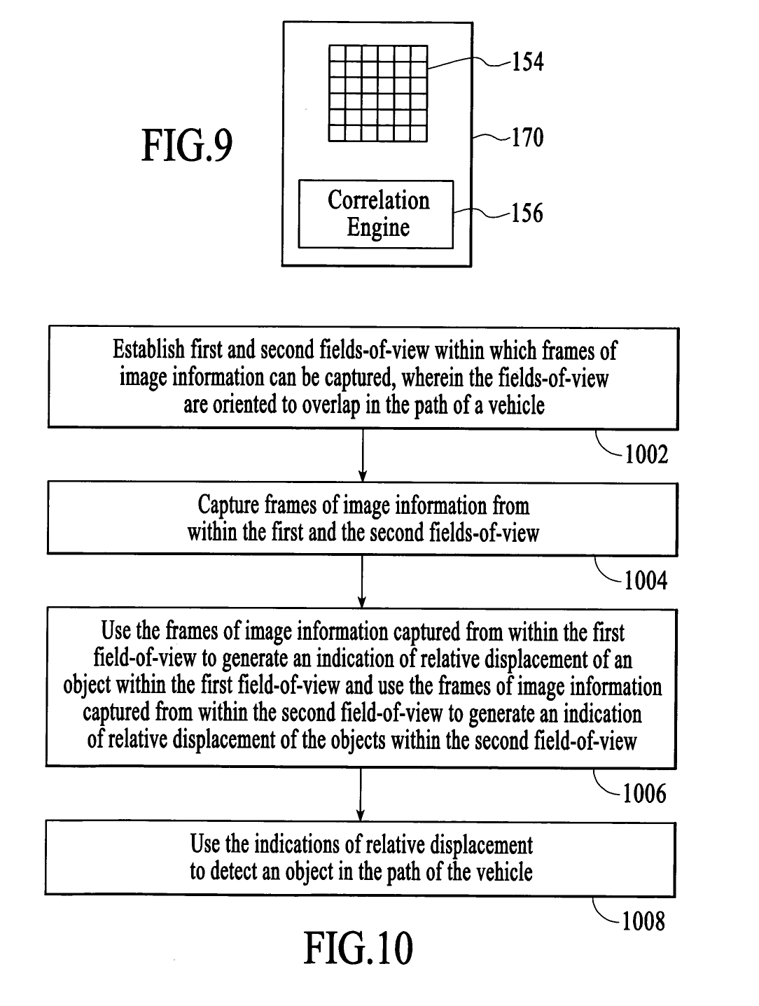

In an embodiment in accordance with the invention, a sensor array that captures image frames and a correlation engine that determines relative movement between image frames are fabricated onto a single integrated circuit (IC) chip. FIG. 9 depicts an example of an IC chip 170 that includes a sensor array 154 and an integrated correlation engine 156.

As described above, the detection coverage area of an object detection system can be expanded by clustering correlation-based motion sensor modules so that their respective fields-of-view are adjacent to each other. Although in the example of FIGS. 4 and 5 each cluster includes six correlation-based motion sensor modules, a detection system with more or less modules in each cluster is possible.

The sensor arrays described above are each an array of distinct photodetectors, for example, a 16×16 or 30×30 array of distinct photodetectors configured to detect incident light. Each of the photodetectors in the array generates light intensity information that is output as a digital value (e.g., an 8-bit digital value). Image information is captured in frames, where a frame of image information includes a set of simultaneously captured values for each distinct photodetector in the array. Image frames captured by the image sensor include data that represents objects in the field-of-view of the image sensor. The rate of image frame capture is programmable and, for example, ranges up to 2,300 frames per second.

FIG. 10 is a process flow diagram of a method for detecting an object in the path of a vehicle. At block 1002, first and second fields-of-view are established within which frames of image information can be captured, wherein the fields-of-view are oriented to overlap in the path of a vehicle. At block 1004, frames of image information are captured from within the first and second fields-of-view. At block 1006, the frames of image information captured from within the first field-of-view are used to generate an indication of relative displacement of an object within the first field-of-view and the frames of image information captured from within the second field-of-view are used to generate an indication of relative displacement of the object within the second field-of-view. At block 1008, the indications of relative displacement are used to detect an object in the path of the vehicle.

Equations 4a and 4b represent the symmetric case in which α=π−β. Although the mathematics are more complicated, the x and y components of an object's velocity can also be found from the angular velocity measurements for the non-symmetric case in which α≠π−β.

Although specific embodiments in accordance with the invention have been described and illustrated, the invention is not to be limited to the specific forms or arrangements of parts so described and illustrated. The scope of the invention is to be defined by the claims appended hereto and their equivalents.

What is claimed is:

1. A system for detecting an object in the path of a vehicle, the system comprising:
two correlation-based motion sensor modules, each of the correlation-based motion sensor modules comprising;
a sensor array configured to generate frames of image information;
optics configured to focus light onto the sensor array;
a correlation engine configured to correlate frames of image information to generate an indication of the relative displacement of an object; and
a detection engine in signal communication with the correlation-based motion sensor modules and configured to use the indications of relative displacement from the correlation-based motion sensor modules to detect an object in the path of a vehicle.

2. The system of claim 1 wherein the correlation engines of the correlation-based motion sensor modules are configured to correlate successive frames of image information to identify changes in the location of the object between successive frames.

3. The system of claim 1 wherein the sensor array and the optics of each correlation-based motion sensor module combine to define a field-of-view of the correlation-based motion sensor module and wherein the two correlation-based motion sensor modules are oriented with respect to each other such that their respective fields-of-view overlap in the path of the vehicle.

4. The system of claim 1 further comprising additional correlation-based motion sensor modules oriented with respect to the two correlation-based motion sensor modules to form additional fields-of-view that overlap in the path of the vehicle.

5. The system of claim 1 wherein the indications of relative displacement are translated to an angular velocity of the object relative to the respective correlation-based motion sensor modules.

6. The method of claim 5 wherein the detection engine is configured to use the angular velocity to determine the linear velocity of the object.

7. The method of claim 5 wherein the detection engine is configured to use the angular velocity to determine the range of the object.

8. The system of claim 5 wherein the detection engine is further configured to establish an angular velocity threshold and compare the angular velocity of the object to the angular velocity threshold.

9. The system of claim 1 wherein the two correlation-based motion sensor modules are attached to the vehicle and oriented with respect to each other such that their respective fields-of-view overlap in the path of the vehicle.

10. A method for detecting an object in the path of a vehicle, the method comprising:
establishing first and second fields-of-view within which frames of image information can be captured, wherein the fields-of-view are oriented to overlap in the path of the vehicle;
capturing frames of image information from within the first and second fields-of-view;
using the frames of image information captured from within the first field-of-view to generate an indication of relative displacement of an object within the first field-of-view;
using the frames of image information captured from within the second field-of-view to generate an indication of relative displacement of the object within the second field-of-view; and
using the indications of relative displacement to detect an object in the path of the vehicle.

11. The method of claim 10 wherein using the frames of image information to generate an indication of relative displacement comprises correlating successive frames of image information to identify changes in the location of the object between successive frames.

12. The method of claim 11 wherein the indications of relative displacement are translated to an angular velocity of the object.

13. The method of claim 12 wherein using the indications of relative displacement to detect an object in the path of a vehicle comprises using the angular velocity to determine the linear velocity of the object.

14. The method of claim 12 wherein using the indications of relative displacement to detect an object in the path of a vehicle comprises using the angular velocity to determine the range of the object.

15. The method of claim 11 further comprising establishing an angular velocity threshold and comparing the angular velocity of the object to the angular velocity threshold.

16. The method of claim 10 further comprising:
establishing a third field-of-view within which frames of image information can be captured, wherein the third field-of-view is adjacent to the first field-of-view;
establishing a fourth field-of-view within which frames of image information can be captured, wherein the fourth field-of-view is adjacent to the second field-of-view and wherein the third and fourth fields-of-view are oriented to overlap in the path of the vehicle;
capturing frames of image information from within the third and fourth fields-of-view;
using the frames of image information captured from within the third field-of-view to generate an indication of relative displacement of an object within the third field-of-view;
using the frames of image information captured from within the fourth field-of-view to generate an indication of relative displacement of the object within the fourth field-of-view; and
using the indications of relative displacement to detect an object in the path of the vehicle.

17. A system for detecting an object in the path of a vehicle, the system comprising:
a vehicle;
two clusters of correlation-based motion sensor modules attached to the vehicle, each of the correlation-based motion sensor modules comprising;
a sensor array configured to generate frames of image information;
optics configured to focus light onto the sensor array;
a correlation engine configured to correlate frames of image information to generate an indication of the relative displacement of an object;
wherein each cluster of correlation-based motion sensor modules has a corresponding combined field-of-view and wherein the two clusters of correlation-based motion sensor modules are oriented with respect to each other such that their respective combined fields-of-view overlap in the path of the vehicle; and
a detection engine in signal communication with the correlation-based motion sensor modules and configured to use the indications of relative displacement from the correlation-based motion sensor modules to detect an object in the path of the vehicle.

18. The system of claim 17 wherein the correlation engines of the correlation-based motion sensor modules are configured to correlate successive frames of image information to identify changes in the location of the object between successive frames.

19. The system of claim 18 wherein the indications of relative displacement are translated to an angular velocity of the object relative to the respective correlation-based motion sensor modules.

20. The method of claim 19 wherein the detection engine is configured to use the angular velocity to determine the range of the object relative to the vehicle and the linear velocity of the object relative to the vehicle.
